(19) United States
(12) Patent Application Publication
(10) Pub. No.: US 2012/0103335 A1
(43) Pub. Date: May 3, 2012

(54) SMOKE ALARM TRIGGERED EMERGENCY PORTABLE BREATHING APPARATUS

(76) Inventor: DANNY CHAGAI ZEEVI, Chatsworth, CA (US)

(21) Appl. No.: 13/204,491

(22) Filed: Aug. 5, 2011

Related U.S. Application Data
(60) Provisional application No. 61/408,161, filed on Oct. 29, 2010.

(51) Int. Cl. A62B 3/00; A62B 17/00; A62B 7/00

(52) U.S. Cl. 128/204.18; 206/216; 169/50; 2/458

(57) ABSTRACT

A bedside emergency unit may be configured to automatically open when a smoke detector/alarm is activated. The bedside emergency unit may include emergency supplies, such as a portable air/oxygen tank, bottled water, a strobe light, a fire blanket and the like. When a smoke detector/alarm activates, the bedside unit may automatically open to provide the user with the emergency supplies stored within. The emergency supplies are then readily available to the user and the open bedside unit serves as a reminder, in a time of possible panic, that certain supplies may be useful to optimize life saving.

### CROSS-REFERENCE TO RELATED APPLICATIONS

This application claims the benefit of priority of U.S. provisional patent application No. 61/408,161, filed Oct. 29, 2010, the contents of which are herein incorporated by reference.

### BACKGROUND OF THE INVENTION

The present invention relates to emergency breathing apparatus and, more particularly, to an emergency portable breathing apparatus, released bedside and triggered by a smoke sensor/alarm.

Most lives are lost due to smoke inhalation in a fire situation. Smoke detectors may wake persons in a fire, but may induce panic without providing any solutions. When a person hears the smoke alarm, the smoke condition may already be too severe to allow the person to safely escape. Portable breathing devices are known in the art to be used in emergency situations. However, people typically store these devices in a drawer or some other location that may prove difficult to retrieve during an emergency.

As can be seen, there is a need for an emergency portable breathing apparatus that may be readily available at a users bedside and that attracts the user to it.

### SUMMARY OF THE INVENTION

In one aspect of the present invention, an emergency kit comprises a housing adapted for mounting to a surface; a door connected by a hinge, to the housing; a trigger mechanism/latch adapted to release the door from being latched to the housing when an emergency sensor is activated; and emergency supplies contained within the housing.

In another aspect of the present invention, an emergency kit comprises a housing adapted for mounting to a surface; a door connected by a hinge to the housing; a trigger mechanism/latch adapted to release the door from being latched to the housing when an emergency sensor is activated; and a portable air/oxygen bottle and a breathing mask.

These and other features, aspects and advantages of the present invention will become better understood with reference to the following drawings, description and claims.

### BRIEF DESCRIPTION OF THE DRAWINGS

FIG. 1 is a perspective view of an alarm triggered emergency kit according to an exemplary embodiment of the present invention;

FIG. 2 is a side view of the emergency kit of FIG. 1; and

FIG. 3 is a top view of the emergency kit of FIG. 1, showing the kit disposed at each side of a user's bed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a bedside unit that may be configured to open when a smoke detector/alarm is activated. The bedside unit may include emergency supplies, such as a portable air/oxygen tank, bottled water, a strobe light, a fire blanket and the like. When a smoke detector/alarm activates, the bedside unit may automatically open to provide the user with the emergency supplies stored within. The emergency supplies are then readily available to the user and the open bedside unit serves as a reminder, in a time of possible panic, that certain supplies may be useful to optimize life saving.

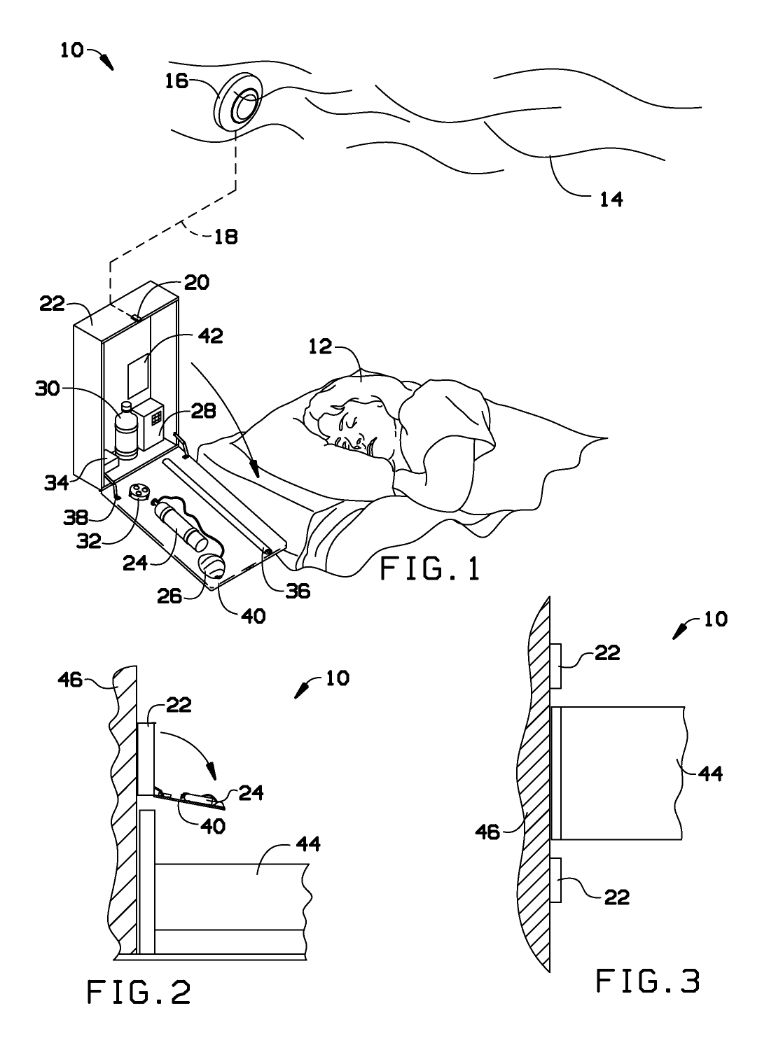

Referring now to FIGS. 1-3, an emergency kit 10 may be provided for a user 12, typically in the user's bedroom, to provide ready access to emergency Supplies stored within. It should be noted that the drawings are not to scale. Typically, the emergency kit may be contained within a housing having a width from about 6 to about 18 inches and a height from about 10 to about 24 inches. The emergency kit 10 may contain an air/oxygen bottle 24, a breathing mask 26, a fire blanket 36 and bottled water 30. The emergency kit 10 may also contain a light 32, such as a light source to alert the user, attract their attention, and to provide light during the emergency. The emergency kit 10 may further contain a speaker/microphone 28 that may sound a variable alert, unlike a smoke detector, to help alert and awaken the user 12 from his or her bed 44. The emergency kit 10 may further include an instruction card 42 to provide instructions to the user 12 during the emergency situation. In some alternate embodiments, a cellular phone may be incorporated into the emergency kit 10. In this embodiment, when the emergency kit 10 is activated (as described below), the cellular phone may dial 911 while the speaker/microphone 28 sounds an audible alert. Once the 911 call is connected, the speaker/microphone 28 may be used to provide communication to/from a 911 operator.

The supplies in the emergency kit 10 may be contained within a housing 22 of the emergency kit 10. The housing 22 may be mounted on a wall 46. In some embodiments, the housing 22 may be mounted in the wall 46 with a door 40 of the emergency kit 10 being flush or near flush with the wall 46. In some embodiments, two emergency kits 10 may be disposed on each side of the bed 44.

The door 40 may connect to the housing 22 by one or more hinges 38. The door 40 maybe retained in a closed position by a trigger mechanism/latch 20. The door 40 may contain exterior artwork, or the like, to provide an aesthetically pleasing appearance. When smoke 14 is detected, for example, by a smoke sensor 16, the smoke sensor 16 may send a signal to release the trigger mechanism/latch 20. The door 40 may be designed to automatically swing open due to gravity when the trigger mechanism/latch 20 is released. In some embodiments, the hinges 38 may be actuated to open the door 40 when the trigger mechanism/latch 20 is released. In some embodiments, the smoke sensor 16 may be connected to the trigger mechanism/latch 20 with a wire 18. In other embodiments, the trigger mechanism/latch 20 may include a sound detecting device that may detect a smoke detector alert and automatically release the trigger mechanism/latch 20 when the smoke sensor 16 is providing its alert sound. In still other embodiments, the trigger mechanism/latch 20 may include a wireless receiver to receive a wireless signal sent from the smoke sensor 16.

The emergency kit 10 may include its own battery backup power supply 34. The battery backup power supply 34 may permit the trigger mechanism/latch 20, the speaker 28 and the strobe light 32 to function, even if main household power is unavailable.

While the above description describes the use of the emergency kit 10 in a home environment, the emergency kit 10 may be useful in various commercial and industrial environments, such as mines, hotels, garages, manufacturing facilities, and the like.

It should be understood, of course, that the foregoing relates to exemplary embodiments of the invention and that modifications may be made without departing from the spirit and scope of the invention as set forth in the following claims.

What is claimed is:

1. An emergency kit comprising:
a housing adapted for mounting to a surface;
a door connected by a hinge to the housing;
a trigger mechanism/latch adapted to release the door from being latched to the housing when an emergency sensor is activated; and
emergency supplies contained within the housing.

2. The emergency kit of claim 1, wherein the emergency supplies includes a portable air/oxygen bottle and a breathing mask.

3. The emergency kit of claim 2, wherein the emergency supplies further includes a fire blanket and bottled water.

4. The emergency kit of claim 1, further comprising a speaker adapted to sound an audible alert when the trigger mechanism/latch is released.

5. The emergency kit of claim 1, further comprising a light adapted to illuminate when the trigger mechanism/latch is released.

6. The emergency kit of claim 1, further comprising a battery backup power supply.

7. The emergency kit of claim 1, wherein the trigger mechanism/latch is hard wired to the emergency sensor.

8. The emergency kit of claim 1, wherein the door is configured to automatically open with the trigger mechanism/latch is released.

9. An emergency kit comprising:
a housing adapted for mounting to a surface;
a door connected by a hinge to the housing;
a trigger mechanism/latch adapted to release the door from being latched to the housing when an emergency sensor is activated; and
a portable air/oxygen bottle and a breathing mask.

10. The emergency kit of claim 9, further comprising:
a fire blanket;
bottled water;
a speaker adapted to sound an audible alert when the trigger mechanism/latch is released;
a light adapted to illuminate when the trigger mechanism/latch is released; and
a battery backup power supply.
